(19) United States
(12) Patent Application Publication
(10) Pub. No.: US 2003/0142811 A1
(43) Pub. Date: Jul. 31, 2003

(54) CLEC to CLEC service provisioning

(76) Inventor: Joe Teixeira, Mount Royal (CA)

Correspondence Address: SWIDLER BERLIN SHEREFF FRIEDMAN, LLP, 3000 K STREET, NW, BOX IP, WASHINGTON, DC, 20007, US

(21) Appl. No.: 10/058,274

(22) Filed: Jan. 30, 2002

(51) Int. Cl. H04M 3/00; H04M 7/00

(52) U.S. Cl. 379/327; 379/219

(57) ABSTRACT

A system and method is deployed to automate the ILEC provisioning process within each central office, or other point of presence, location. The solution helps substantially reduce the effort required by the ILEC to fulfill collocation provisioning responsibilities, while at the same time speeding up the provisioning cycle time frame. It is deployed between the CLECs and outbound central office lines in order to automate CLEC service provisioning, ILEC service provisioning and CLEC to CLEC service provisioning thus allowing ILECs to conform with new and existing FCC regulations in an efficient and cost effective manner.

### FIELD OF THE INVENTION

The present invention relates in general to systems and methods for provisioning telecommunications services and, more particularly, to provisioning services between competitive local exchange carriers (CLECS), each with its own leased or owned equipment, within a telecommunications network controlled by one or more incunbent local exchange carriers (ILECs) in an automated manner controlled remotely and centrally by each ILEC.

### BACKGROUND OF THE INVENTION

In November 1999, the Federal Communications Commission (FCC) in the United States ruled that Incumbent Local Exchange Carrier (ILECs) must share lines with any Competitive Local Exchange Carrier (CLECs). The goal was to provide consumers with a cost-effective solution for receiving differentiated data services.

On Aug. 8, 2001, the FCC released a collocation remand order (CRO) identifying new rules allowing CLEC's to collocate multifunction equipment for switching and routing and requiring ILEC's to provision cross connects between CLECs in ILEC central offices. The new CRO ruling adds more responsibilities to ILECs. The order requires ILECs to provision cross-connects between CLECs in a reasonable time frame. This causes an immediate resource problem for the ILECs. The ILECs have already committed human resources to providing services for CLEC collocation and provisioning and have often complained of not being able to keep up with the added provisioning demands placed on them by the CLECs. The collocation remand order puts further demands on the scarce resources of ILECS.

In view of the collocation remand order, there is a need for a system and method that ILECs may easily deploy for providing cross connections between CLECs. There is a further need for a cross connect system and method that ILECs may use to interconnect CLECs that fits into existing telecommunications infrastructure. There is still a further need for a cross connect system and method that ILECs may use to automatically and remotely configure services between CLECs at each remote central office maintained by the ILECs that provides service provisioning between CLECs without requiring additional human resources at each central office or otherwise within the ILEC.

### SUMMARY OF THE INVENTION

According to the present invention, a system and method is deployed to automate the ILEC provisioning process within each central office, or other point of presence, location. The solution helps substantially reduce the effort required by the ILEC to fulfill collocation provisioning responsibilities, while at the same time speeding up the provisioning cycle time frame. Thus the system and method according to embodiments of the present invention, automate provisioning to alleviate tensions between both parties and to allow them to work closer together for the benefit of their respective customers. The system and method according to embodiments of the present invention is deployed between the CLECs and outbound lines in order to automate CLEC service provisioning, ILEC service provisioning and CLEC to CLEC service provisioning thus allowing ILECs to conform with new and existing FCC regulations in an efficient and cost effective manner.

According to another embodiment of the present invention, a cross connect physical layer switching system is integrated into each ILEC central office (CO) or other point of presence. The cross connect physical layer switching system may be used to facilitate aspects of delivering data services, such as digital subscriber line (DSL) service, to subscribers over a shared data and voice line. For example, the cross connect physical layer switching system may be used for service provisioning, test access for loop qualification, service migration and fallback switching to help reduce the deployment and maintenance time for high-speed data services. The cross connect physical layer switching system may be placed between a splitter and the shared line to allow a remote test unit to be controllably connected to the shared line to permit testing of the shared line by the CLEC and ILEC.

According to another embodiment of the present invention, CLEC to CLEC service provisioning is performed by the cross connect physical layer switching system by a remote terminal operated by the ILEC. The remote control allows the provisioning of CLEC to CLEC services, CLEC services and ILEC services in an automated manner from a central location. This prevents truck rolls to the CO and allows ILECS to accomplish more service provisioning with the same or fewer resources.

### BRIEF DESCRIPTION OF THE FIGURES

The details of the present invention, both as to its structure and operation, can best be understood with reference to the accompanying drawings, in which like reference numbers and designations refer to like elements.

FIG. 1 is a block diagram of a prior art telecommunications system implementing a splitter device for a co-location scheme.

FIG. 2 is an exemplary block diagram of telecommunications system, according to the present invention, implementing xDSL service.

FIG. 3 is an exemplary flow diagram of a process of operation of the present invention, implemented in the system shown in FIG. 2.

FIG. 4 depicts a method for providing shared line access for data and voice services that permits full spectrum test access for both the data service provider and the voice service provider.

FIG. 5 is an exemplary block diagram of a network management system shown in FIG. 2.

FIG. 6 is an exemplary block diagram of a cross connect switch shown in FIG. 2.

FIG. 7 shows an exemplary matrix board included in the cross connect switch shown in FIG. 6.

FIG. 8 shows an example of cross point connection in the matrix board shown in FIG. 7.

FIG. 9 shows an exemplary cross point connection pin used to establish a cross point connection in the matrix board shown in FIG. 7.

FIG. 10 shows an exemplary robotic cross connector included in the cross connect switch shown in FIG. 6.

FIG. 11 is an exemplary block diagram of an apparatus that verifies proper connection of a cross point connection pin shown in FIG. 9.

FIG. 12 shows an example of matrix boards in relation to the robotic cross connector.

FIGS. 13-18 illustrate some standard 3 dimensional connection paths, which are completed by the cross connect switch in response to commands.

FIG. 19 is an exemplary embodiment of a cross connect switch within a central office for automating CLEC to CLEC interconnection.

FIG. 20 is an exemplary embodiment of an arrangement for controlling cross connect switches for controlling CLEC to CLEC interconnection within diverse central offices.

FIG. 21 depicts an exemplary embodiment of a method for controlling CLEC to CLEC interconnection within a central office.

### DETAILED DESCRIPTION

### Introduction

In November 1999, the Federal Communications Commission (FCC) in the United States ruled that Incumbent Local Exchange Carrier (ILECs) must share lines with any Competitive Local Exchange Carrier (CLECs). The goal was to provide consumers with a cost-effective solution for receiving differentiated data services. The ruling (FCC 99-355) allowed ILECs to maintain the low frequency portion of the telecom line providing voice transmission and for CLECs to use the high frequency segment for data access solutions.

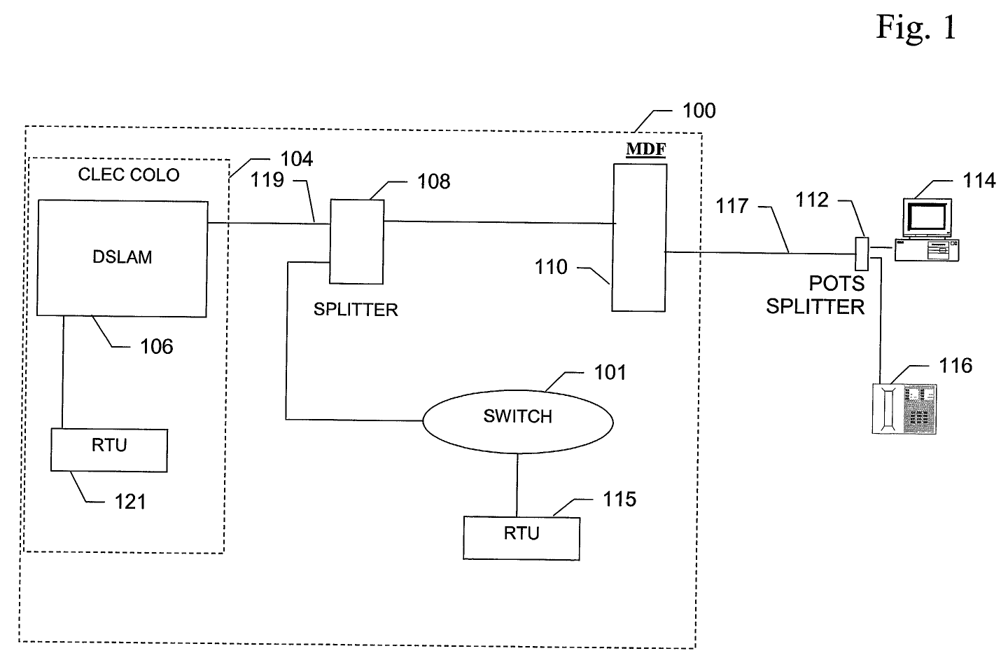

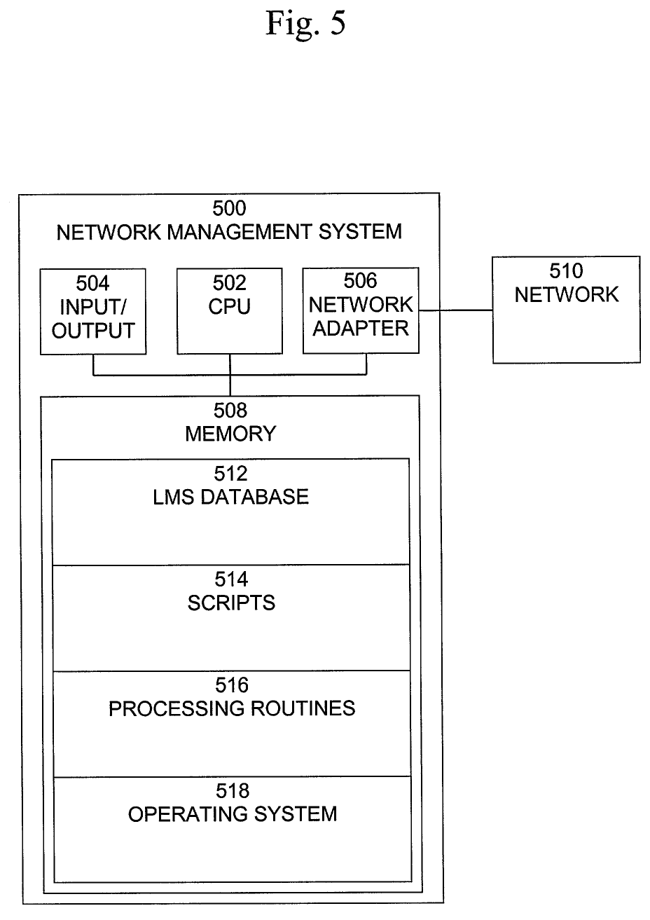

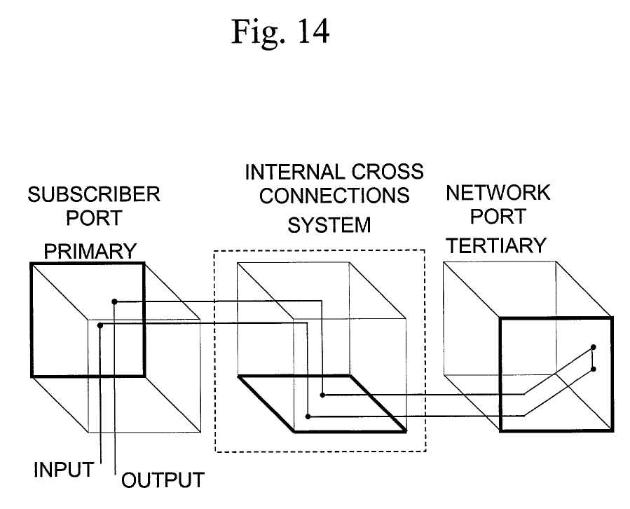

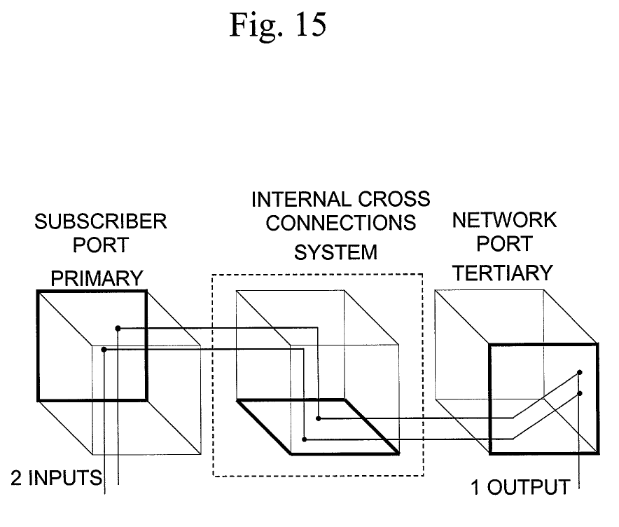

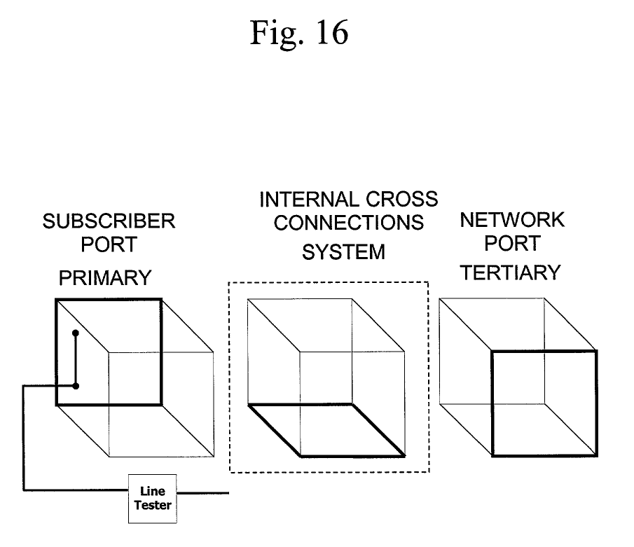

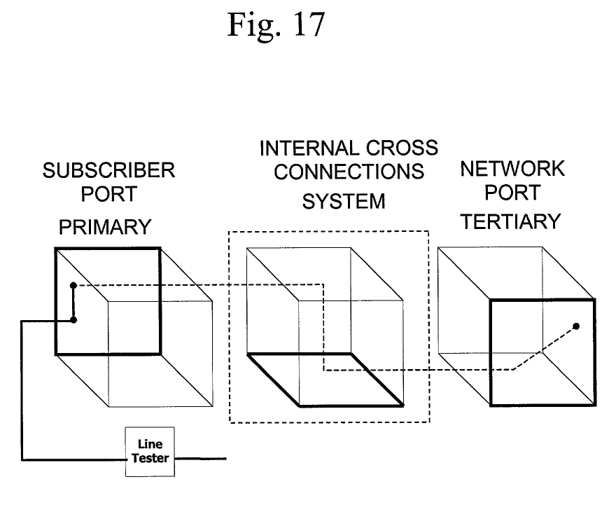

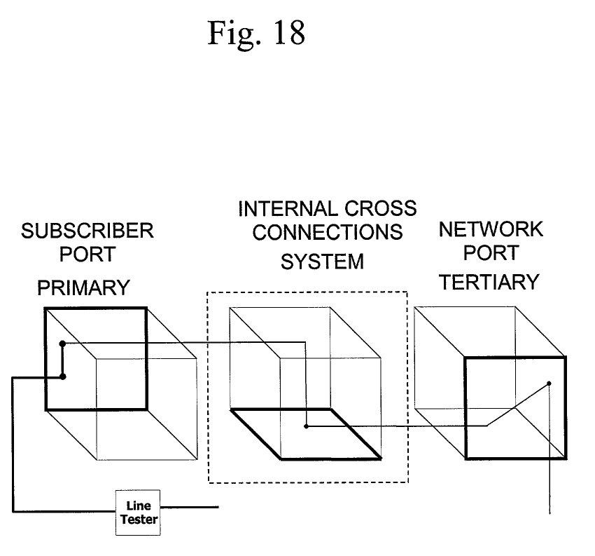

In response to this FCC ruling, ILECS have responded by permitting CLECS to co-locate data services, such as DSL services, within their facilities. A discussion of conventional arrangement (FIG. 1) and innovative arrangements (FIGS. 1-4) for line sharing between CLECS and ILECS are shown and described with reference to these figures below in the section entitled Line Sharing. FIGS. 5-18 describe in detail an embodiment of a cross connect switch and techniques for implementing centralized remote control of one or more cross connect switches implemented within one or more diverse Central Office locations over local area and/or wide area networks.

### CLEC to CLEC Provisioning

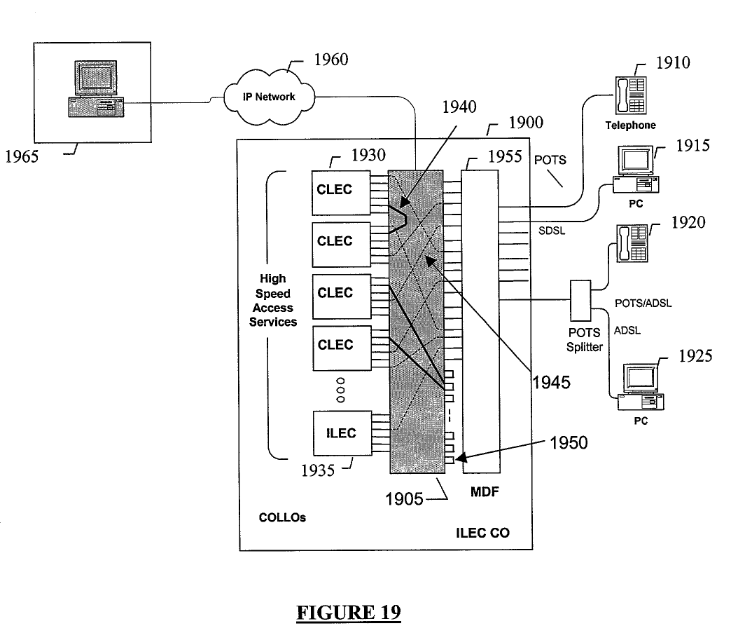

2. FIG. 19 depicts an embodiment of CLEC to CLEC provisioning according to the present invention. Referring to FIG. 19, a ILEC central office 1900 includes a plurality of collocated CLEC equipment 1930. The equipment 1930 includes a plurality of ports for providing services. In general, the equipment 1930 is switching and/or routing equipment. According to one embodiment of the invention, the equipment 1930 is a digital subscriber line access multiplexer (DSLAM). The DSLAM may be of the ADSL, SDSL, HDSL VoDSL, SHDSL, VDSL or other type.

The central office 1900 includes a main distribution frame 1955 that is coupled to a lines that feed remote subscriber equipment as shown. For example, a plain old telephone service (POTS) line couples the central office to the telephone 1910; a SDLS line couples the central office 1900 to the PC 1915; a POTS/ADSL line couples the central office to a telephone 1920 and a PC 1925 over a shared line.

Referring to FIG. 19, the ILEC and the CLECs have a plurality of ports that are coupled to the cross connect switch 1905. The cross connect switch 1905 forms interconnections under the control of a remote client 1965 that is connected to the cross connect switch 1905 via a local area or wide area network 1960. The cross connect switch may make several different types of connections to facilitate various types of CLEC to CLEC coupling (as well as CLEC to ILEC coupling and CLEC and ILEC to subscriber coupling). The cross connect may be controlled to form an internal loop back connection 1940 as shown in FIG. 19. This may be used to interconnect one port of a CLEC 1930 to another port of a different CLEC 1930. The cross connect switch 1905 maybe controlled to form an external loop back connection 1950 to connect one port of a CLEC 1930 to another port of a different CLEC 1930. In addition, the cross connect switch 1905 may be used to form connections between the ILEC 1935 and CLEC 1930 ports and the MDF 1955 which in turn couples these ports to subscriber lines.

When a pair a CLECs reach agreement on the deployment of services, the CLECs may decide to interconnect ports of their respective equipment 1930. The interconnection may allow one CLEC to expand its DSL service offering by leasing, for example, capacity from another CLEC. The leased capacity may represent an entirely new service for the lessee or may represent an expansion of existing services. The interconnection may also be performed to reflect the purchase or exchange of services by one CLEC from another. Various other types of interconnection arrangements may be made to facilitate CLEC to CLEC service offerings including testing.

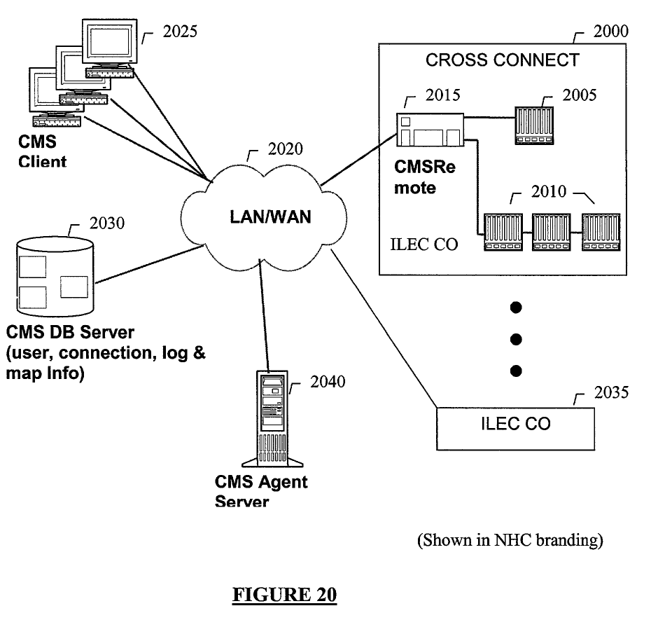

FIG. 20 depicts a network view of a remote control aspect of the cross connect deployment described above with reference to the CLEC to CLEC provisioning shown in FIG. 19. Referring to FIG. 20, a network operations center (NOC) is a centrally located facility that includes a CMS client 2025, a CMS database server 2030 and a CMS agent server 2040. These network elements within the NOC are used to provide a facility for an ILEC employee to interact with the client terminals 2025 to remotely create interconnections between one or more specific ports of one CLEC to one or more specific ports of another CLEC. The solution is directed to remotely provisioning between CLEC Collocation closets, for which the responsibility now falls under the ILEC as outlined in the Aug. 8, 2001 collocation remand order. The NHC system solution is marketed under the name ControlPoint and will be referred to as such from this point forward.

ControlPoint consists of three primary components, the “CMS Client/Server” management software platform, the “CMS Remote” controller and the “ControlPoint” cross-connect matrix. The system allows an ILEC provisioning operator to control the cross-connect matrix at a distance via the CMS Client GUI software, from a central Network Operating Center (NOC) location. Thus a user can remotely provision lines without necessitating a truck roll, whereby a technician would otherwise need to drive to a remote CO and/or Collocation site to physically perform the required cross-connects on site. The CMS Remote and ControlPoint Cross-connect are physically located at each CO and Collocation closet where remote management is desirable.

The following diagram depicts the NHC ControlPoint system. The CMS Client 2025 is used by the ILEC to issue commands. Typically there will be more than one such CMS Client, depending on the number of operators tasked with provisioning. The commands are specific commands to connect one ore more ports to one or more other ports. The Client 2025 may access a CMS database server for serving to the Client 2025 information about the present configuration of the cross connection switch on a port by port basis. The Client may graphically display this information to a user of the Client 2025. The user may then make a provisioning change by manipulating the existing port configuration. The provisioning changes is then issued as a command by the Client 2025.

These commands are sent over the LAN 2020 using a protocol to a CMS Agent Server 2040. One CMS Agent Server 2040 may handle many CMS Remote/ControlPoint cross-connect combinations. The CMS Agent Server organizes the provisioning requests from the various CMS Clients and communicates with the appropriate CMS Remote over the LAN/WAN using SNMP, TCP or similar protocol. The CMS Remote may be serially connected to the ControlPoint cross-connect (3 cross-connects are shown coupled in series and may be connected to a single CMS Remote) and send the matrix the commands that have been received over the LAN/WAN. Alternatively, the CMS Remote may be connected in parallel to the cross connect switching matrix. The system protocol is designed to communicate back and forth in order to ensure data integrity and maintain synchronization between the actual configuration of the cross connect switch and the configuration represented in the database 2030.

Upon successful completion of a connection, the CMS remote 2015 returns a confirmation to the CMS Agent server which then sends the confirmation to the database server 2030 to update the database to reflect the new connection. In this manner, the database reflects the current configuration of the cross connect switch. The NOC may be located in a single place that is used to control a plurality of diverse central offices as shown. The client systems may be distributed geographically and connected to the database 2030 and the agent server 2040 through the LAN/WAN 2020.

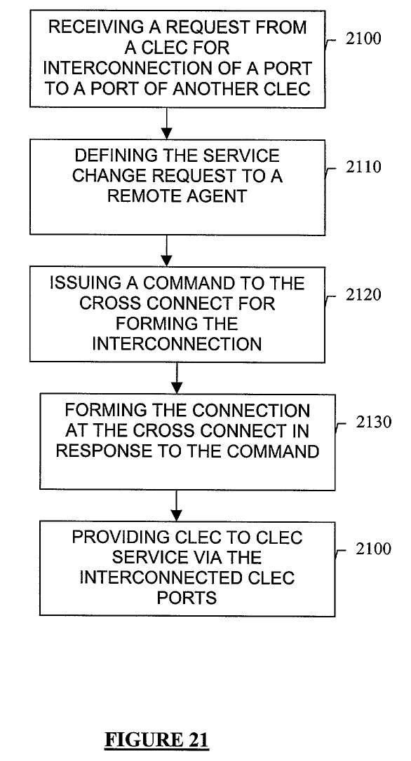

FIG. 21 depicts a method of automatically forming cross connections between CLEC equipment via a remote control terminal. The method includes receiving a request from a CLEC for interconnection of a port of a piece of equipment to another port of equipment belonging to another CLEC. The equipment may be DSLAM equipment or other switching or routing equipment. The CLEC's may communicate this request in any manner to personnel at the ILEC. The request may be generated automatically and sent, for example, from an information system used to provision services at the CLEC via an electronic message to the ILEC personnel, the ILEC client 2025 or an intermediate information system of the ILEC.

In step 2110, personnel of the ILEC define the service change request to the Client 2025. This is typically done by personnel at the client system 2025 interacting with information stored in the database server 2030. The information stored in the database may present a graphical depiction or other convenient representation of the present configuration of the switch. The user of the system 2025 may then interact with the system to define the service change. The service change may be a CLEC to CLEC connection, a CLEC to ILEC connection, a CLEC to MDF connection or an ILEC to MDF connection.

In step 2120, the client system issues a command to the cross connect for forming the interconnection. The command may be transmitted across the LAN/WAN 2020 to the Agent Server which in turn processes and forwards the command to the CMS remote 2015 for processing. Then in step 2130, the cross connect forms the connection in response to the command. In step 2140, service is provided pursuant to the interconnected CLEC ports.

As is explained below, lines from the central office may be shared by a CLEC and ILEC with a mutually convenient testing arrangement facilitated by the cross connect. The shared line may also be used to provide shared service between a CLEC to CLEC coupled service and POTS ILEC service.

### Line Sharing

Referring to FIG. 1, the ILEC company 100 includes a switch 101 coupled to a MDF 110 through a splitter 108 that provides conventional voice service to subscribers 116 over a shared line 117. The telephone switch 101 connects calls originated by the subscriber to other telephones via a communications network (not shown). The switch also connects incoming calls from the communications network to subscriber telephones 116.

The ILEC company permits a CLEC company 104 to provide co-located data services via the splitter 108 and shared line 117 to subscriber terminal 114. The data services may be, for example, digital subscriber line services (DSL) which is one of the signal protocols being used to carry broadband digital data over existing two-wire telephone lines. There are several versions of DSL in common use. Asymmetric DSL (ADSL) provides greater bandwidth for downstream data than for upstream data. In addition, ADSL reserves a portion of the available channel bandwidth for support of traditional analog telephone service (Plain Old Telephone Service (POTS)). ADSL is aimed primarily at the residential market. Another version of DSL is Symmetric DSL (SDSL). SDSL provides equal bandwidth in both the upstream and downstream directions and does not provide support for POTS. SDSL is better suited to business applications, such as network server communications, etc.

In order to provide, conventional DSL service from the CLEC 104 as shown, the CLEC 104 may deploy a digital subscriber line access multiplexer (DSLAM) 106. The DSLAM 106 is a system that links customer DSL connections to an IP network. Typically, the IP network is the Internet, but may be any public or private data transport network.

In order to provide shared voice and data services, the splitter 108 is conventionally implemented as shown in FIG. 1. The splitter is connected to the DSLAM 106, the switch 101 and to the shared line 117. The shared line 117 is typically that portion of the shared line 117 received from the MDF. The splitter 108 is used to separate the higher frequency portion of the line going to the CLEC collocation from the low frequency portion being used by the ILEC. The splitter 108 is also used to block the ILEC from providing high frequency signals on the shared line and to block the CLEC from providing low frequency signals on the shared line.

Another splitter 112 is conventionally used at the subscriber premises to split the high-frequency data service signal from the POTS voice signal and deliver the signals respectively to a data modem on a subscriber terminal 114 and to the subscriber telephone 116.

In order to perform testing of lines extending from the ILEC central office 100 to subscribers, a remote test unit 115 is conventionally used by ILECs to perform narrow band testing of the local loop. The remote test unit 115 performs testing of the shared line 117 through the switch 101, the splitter 108, the MDF 110 and the splitter 112. Unfortunately, the conventional arrangement of FIG. 1 hampers the CLEC's ability to perform full spectrum testing on the local loop. This is because the splitter 108 inhibits the ability of the RTU 121 to test the local loop at low frequencies when the RTU 121 is connected to the high frequency portion of the line 119 maintained by the CLEC 104.

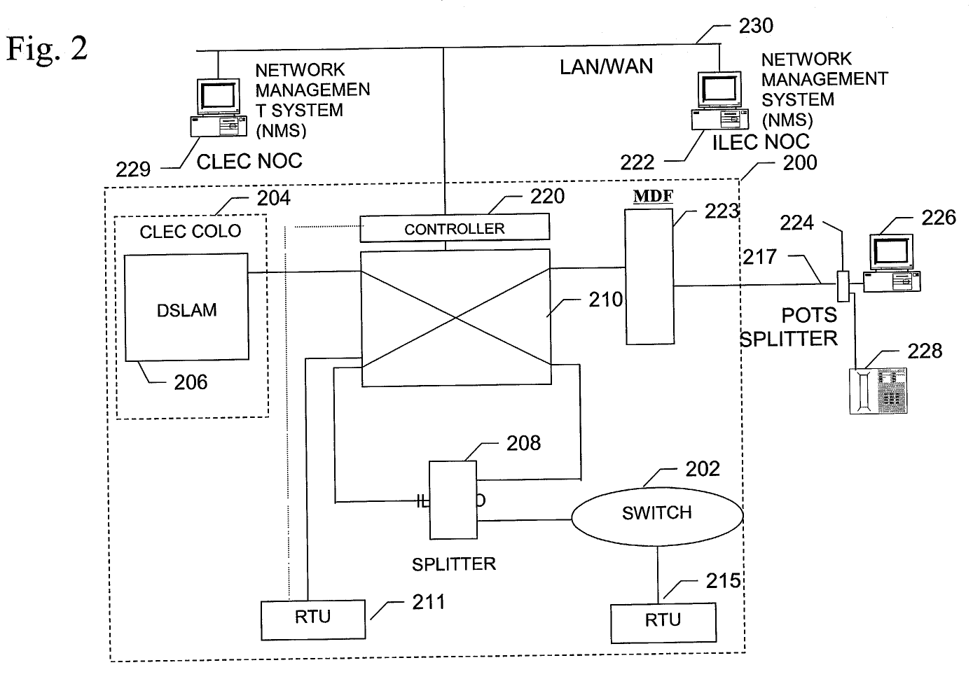

In order to overcome these problems and permit full spectrum testing by the CLEC 104 of the local loop, the arrangement in FIG. 2 may be implemented according to an embodiment of the present invention. This arrangement allows the ILEC to comply with the FCC ruling and provide full test access capability to the CLEC.

Referring to FIG. 2, a cross-connect switch 210, such as the CONTROLPOINT™ switch available from NHC, may be implemented to facilitate full spectrum test access by the CLEC in addition to the ILEC. As used herein, the terms cross-connect and cross-connect switch are intended to mean any switch capable of reliably interconnecting telecommunications signals, including voice and data signals, from inputs to outputs under the influence of internal or external control signals. The terms are intended to encompass any such switch and control systems, including loop management systems. To illustrate the operation of an embodiment of a cross-connect switch 210 and the manner in which it is controlled, the CONTROLPOINT switch available from NHC is hereafter briefly described.

The CONTROLPOINT solution is NHC's integrated non-blocking copper cross-connect system that helps CLECs and ILECs qualify and provision DSL and other services remotely without the need to enter the CLEC's COLLO or ILEC's CO. The CONTROLPOINT solution works with third party Remote Test Units, enabling the cross-connect to be used as a test access platform for rapid loop qualification. The CONTROLPOINT solution may be deployed for DSL test access for local loop qualification, provisioning, migration and fallback switching. The CONTROLPOINT solution is intended to work with every major DSLAM and Remote Test Unit vendor.

The CONTROLPOINT cross-connect hardware has a matrix size and loopback capabilities that allow multiple services to be provisioned and migrated remotely on-the-fly and on-demand, thereby minimizing truck-rolls needed to qualify and provision high speed data services. The CONTROLPOINT solution allows the service provider to migrate users to higher speed data services quickly. The CLEC has the ability to use any available port on the DSLAM for fallback switching thus providing added value to both the CLEC and the subscriber.

The CONTROLPOINT solution is managed via two-key elements: CONTROLPOINT CMS 222, 229 and CONTROLPOINT CMS Remote (Controller) 220. CONTROLPOINT CMS 222 and 229 is the control and management software for NHC's CONTROLPOINT Solution. Elements 222 and 229 are later referred to generically as network management systems (NMS) and also as terminals. CONTROLPOINT CMS 222 and 229 communicate with NHC's CONTROLPOINT Copper Cross-Connect 210 via the CONTROLPOINT CMS Remote Controller 220 to allow voice and high-speed data service providers to take full control of their copper cross-connect infrastructure.

CONTROLPOINT CMS controls and tracks the physical connections within the CONTROLPOINT matrix, along with vital subscriber and equipment information. CONTROLPOINT CMS features an intuitive Graphical User Interface (GUI) for greater ease of use. Port connections involve a simple drag & drop operation. Through services provided by the CMS Agent Server, CONTROLPOINT CMS is able to query the CMS Database which tracks CONTROLPOINT subscriber/service connections and organizes the network into multi-level geographical views by country, city and site location.

CONTROLPOINT CMS Remote is the SNMP control interface for NHC's CONTROLPOINT copper cross-connect switch, which allows the CONTROLPOINT cross-connect 210 to be managed via NHC's CONTROLPOINT Control and Management Software (CMS) or managed via third party Network Management System (NMS). The CONTROLPOINT CMS Remote is connected to an Ethernet LAN and is accessible via standard SNMP, TCP or similar commands (support for TL1 and CORBA may also be possible). The CONTROLPOINT CMS Remote connects to CONTROLPOINT cross-connect via serial link. The device receives standard SNMP, TCP or similar commands from the CMS Agent Server which originated from the NMS or CONTROLPOINT CMS and communicates them to the CONTROLPOINT cross-connect. Support for API (application interfaces) within the CONTROLPOINT CMS Remote and CONTROLPOINT CMS allows for customization to support NHC's proposed line-sharing solution.

While the CONTROLPOINT switching system may be used to implement the cross-connect switch, it will be understood that any remotely controllable cross-connect switching system may be implemented according to embodiments of the present invention. The cross-connect switch 210 and its controllers are hereafter referred to generically. Also, the terms cross-connect switch and cross-connect are used interchangeably.

The cross-connect 210 may be placed between the MDF 223 and the splitter 208. The cross-connect 210 may also be placed between the DSLAM 206 and the MDF 223. The data service, access to which is provided through the DSLAM 206, is controllably connected through the cross-connect 210 to the splitter 208 back through cross-connect 210 and to the shared line 217. The shared line 217 extends through the MDF 223 to the customer premises equipment which includes a splitter 224. The splitter 224 provides the high frequency data service to the terminal 226 and the lower frequency voice service to the telephone 228.

The telephone switch 202 of the ILEC 200 is coupled to the low frequency portion of the splitter 208, which is also maintained by the ILEC. The RTU 215, is used by the ILEC for narrow band testing of the local loop, may be coupled to the shared line 217 through the switch 202, the splitter 208, cross-connect 210 and the MDF 223. The RTU 211 used by the CLEC 204 may be controllably connected to the shared line 217 through the cross-connect 210 for monitoring and testing.

A network management system (NMS) or other terminals 222 or 229 may be used to control the cross-connect and the RTU 211 via any standard or proprietary network, such as a local area network (LAN) or a wide area network (WAN). The terminals 222 or 229 can control the configuration and operation of the cross-connect 210 over the network 230 and can determine the status and configuration of cross connect switch 210 over network 230.

In one configuration, the terminals 222 and 229 may be coupled to a controller 220 that controls the making of connections within the cross-connect 210. The terminals 222 and 229 may be remotely located from the ILEC CO 200 thus permitting remote control of provisioning of the data service, and the terminals 222 and 229 may provide remote control of testing by the CLEC 204. The terminals 222 and 229 may be used to send commands to the controller 220 to cause connections within the cross-connect switch 210. The terminals 222 and 229 may also send commands to the RTU 211 (possibly via the controller 220). The commands sent to the controller may include a command to connect the RTU to a shared line 217, to connect the splitter output to the shared line 217, and to send other commands or data to the RTU 211 or the controller 220. The commands sent to the RTU may include commands to monitor a shared line 217 for on-hook and/or off-hook conditions, to conduct full-spectrum (both narrow and wide band) local loop line testing or other testing of the shared line and to return data to the terminal 222 and/or 229. The commands may be sent directly to the RTU 211 or may be sent via the controller 220.

In the event that a terminal 222 or 229 issues a command to monitor the line, the controller will cause the RTU 211 to connect to the shared line 217 and the RTU 211 will conduct a monitoring test to determine whether the line is on or off hook.

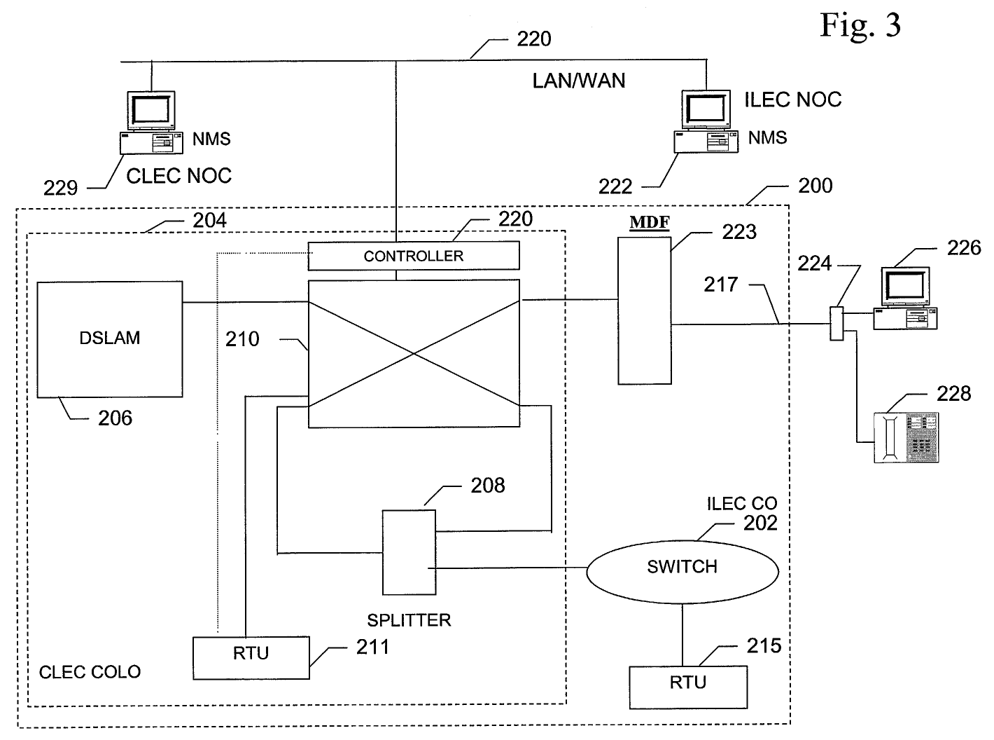

FIG. 3 depicts an embodiment of the invention in which the cross-connect 210, the splitter 208 and the RTU 211 are part of the CLEC 204 rather than the ILEC. This scheme and other variations may be implemented depending on the division of responsibilities between the CLEC 204 and the ILEC 200. In general, the ILEC or the CLEC may control any of the functional elements depicted in FIGS. 2 and 3.

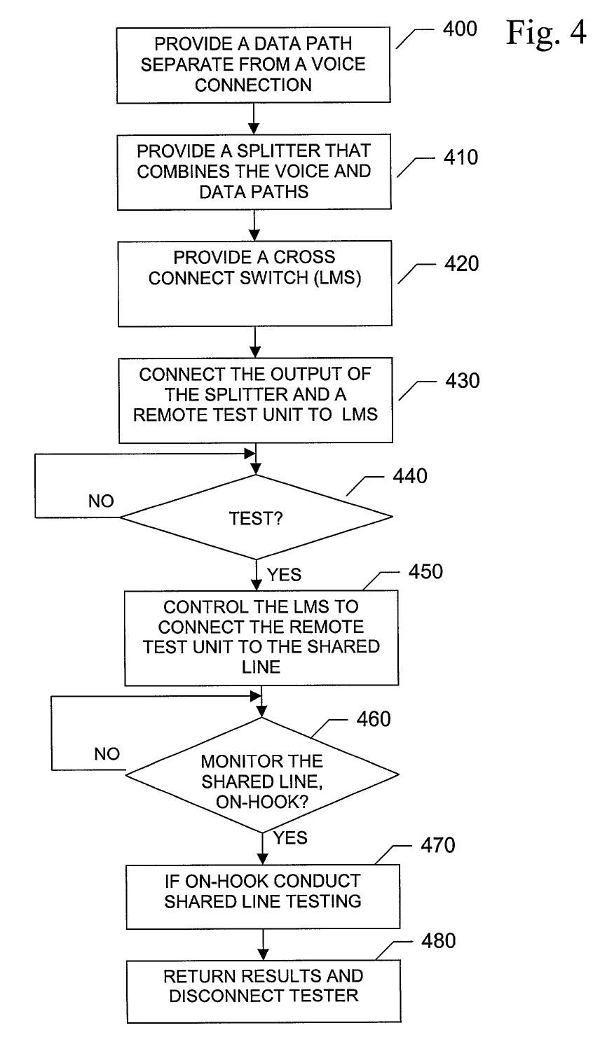

FIG. 4 depicts a method of providing full spectrum test access for a data service within an ILEC. Referring to FIG. 4, in step 400, a data path separate from a voice path is provided in a telecommunications facility such as a central office. The data path may be a path to a DSLAM 206 for providing DSL service. In step 410, a splitter 208 is provided that couples the separate data and voice paths with a shared line. In step 420, a cross connect switch 210 or loop management system is provided. The data path may be coupled to the splitter through the cross-connect switch 210 in order to facilitate service provisioning. Then in step 430, the output of the splitter 208 and a remote test unit 211 are connected to the cross-connect 210.

In step 440, if a test of a shared line is not required, then step 440 begins again. If a test of a shared line is required, then step 450 begins. In step 450, the terminal 222, 229 or other entity issues a command to the controller 220 to connect the RTU 211 to the shared line 217. In response, the controller 220 controls the cross-connect 210 causing the RTU 211 to be connected to the appropriate shared line. Then in step 460, the RTU 211 monitors the shared line 217 to determine whether the shared line is on-hook. If not, then step 460 is performed again and testing does not proceed. If the shared line is on-hook in step 460, then step 470 begins.

Step 460 protects the ILEC from having its voice service disturbed by the CLEC while a subscriber is actively using the voice service. The ILECs have a major concern that if the CLEC has full-spectrum test access to the shared-line, the CLEC might run its tests while the subscriber equipment is off-hook and therefore interfere with the ILEC's voice service.

In step 470, the RTU 211 conducts full spectrum testing of the shared line 217 through, for example, the cross-connect 210 and the MDF 223. Any testing techniques are contemplated in this step for testing the integrity of the shared line, internal paths within the CLEC or the ILEC or aspects of the customer premises equipment 224-228. As part of step 470, the controller 220 may signal the cross connect switch 210 to disconnect the splitter 208 from the shared line to permit testing of the subscriber line or the service equipment.

In step 480, the RTU 211 returns the results of the testing to an operator. This step may occur by the RTU 211 outputting the results to a display or transmitting data to a remote terminal via a network either directly or via the controller 220. In step 480, the controller 220 may also signal the cross connect switch 210 to disconnect the tester and reconnect the splitter 208 to the shared line to restore the connection of subscription services to the subscriber's line.

An exemplary block diagram of a network management system 500, according to the present invention, is shown in FIG. 5. Network management system 500 is typically a programmed general-purpose computer system, such as a personal computer, workstation, server system, and minicomputer or mainframe computer. Network management system 500 includes processor (CPU) 502, input/output circuitry 504, network adapter 506, and memory 508. CPU 502 executes program instructions in order to carry out the functions of the present invention. Typically, CPU 502 is a microprocessor, such as an INTEL PENTIUM® or similar processor, but may also be a minicomputer or mainframe computer processor. Input/output circuitry 504 provides the capability to input data to, or output data from, computer system 500. For example, input/output circuitry may include input devices, such as keyboards, mice, touchpads, trackballs, scanners, etc., output devices, such as video adapters, monitors, printers, etc., and input/output devices, such as, modems, etc. Network adapter 506 interfaces network management system 500 with network 510. Network 510 may be any standard local area network (LAN) or wide area network (WAN), such as Ethernet, Token Ring, the Internet, or a private or proprietary LAN/WAN, but typically, IP network 230 is the Internet.

Memory 508 stores program instructions that are executed by, and data that are used and processed by, CPU 502 to perform the functions of the present invention. Memory 508 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 508 includes a plurality of blocks of data, such as Loop Management System (LMS) database 512 and scripts block 514, and a plurality of blocks of program instructions, such as processing routines 516 and operating system 518. LMS database 512 stores information relating to cross connect switches that are managed and controlled by NMS 500, including information relating to connections maintained by the cross connect switch. Scripts block 514 includes scripts that are transmitted by NMS 500 to cross connect switches to control the connection of circuits. Processing routines 516 are software routines that implement the processing performed by the present invention, such as receiving SNMP, TCP or similar messages, accessing LMS database 512, transmitting scripts from script block 514, etc. Operating system 518 provides overall system functionality.

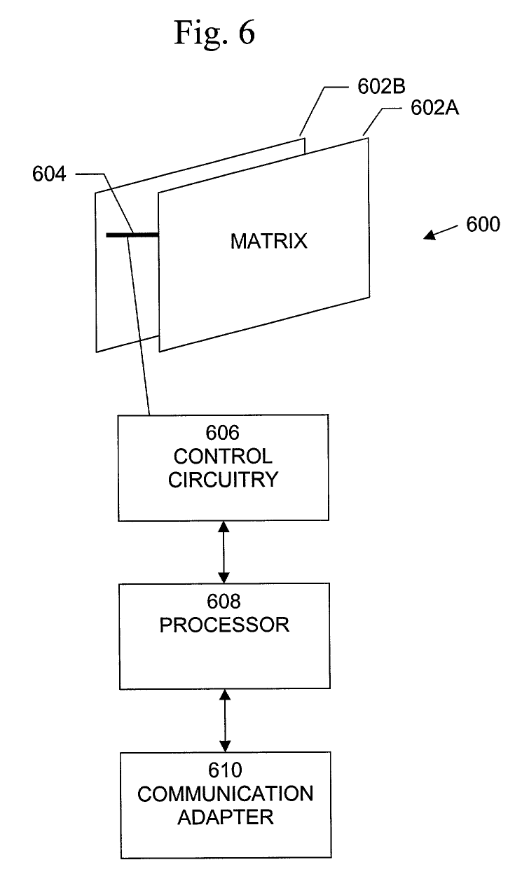

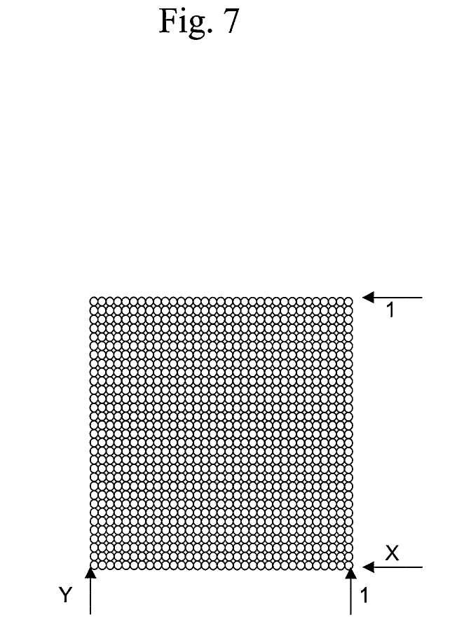

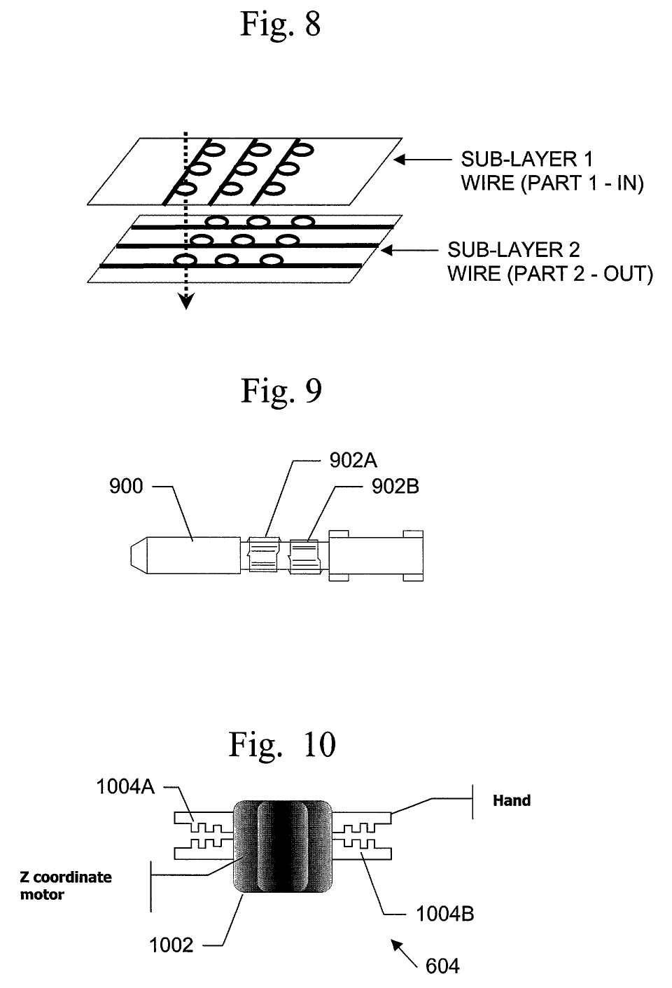

An exemplary block diagram of a cross connect switch 600 is shown in FIG. 6. Switch 600 includes matrix boards 602A and 602B, robotic cross connector 604, control circuitry 606, processor 608 and communication adapter 610. Matrix boards 602A and 602B, an example of which is shown in more detail in FIG. 7, are multi-layer matrices of circuits having holes at the intersections of circuits on different layer. The holes, known as cross points, allow the connection of pairs of circuits on different layers by the use of conductive pins. To make a cross connections, a pin is inserted into one of the holes in a matrix board, as shown in FIG. 8. Each pin, such as pin 900, shown in FIG. 9, has two metal contacts 902A and 902B on the shaft, which create the connection between a pair of input circuits to a pair of output circuits on different layers of the matrix board.

Robotic cross connector 604, an example of which is shown in FIG. 10, provides the capability to move a pin to an appropriate cross point and to insert the pin to form a connection at the cross point or remove the pin to break a cross connection. The mechanism of robotic cross connector 604 is capable of movement in three dimensions, using a separate motor for movement in each dimension. For example, Z-coordinate motor 1002, shown in FIG. 10, provides movement of the mechanism along the Z axis. A pin is carried, inserted and removed by a robotic “hand”, such as hand 1004A or 1004B, which is part of robotic cross connector 604. A fourth motor controls the robotic hand. 1004A and 1004B to grasp and release pins.

Control circuitry 606 generates the signals necessary to control operation of robotic cross connector 604, in response to commands from processor 608. Processor 608 generates the commands that are output to control circuitry 606 in response to commands received from the network management system via communication adapter 610.

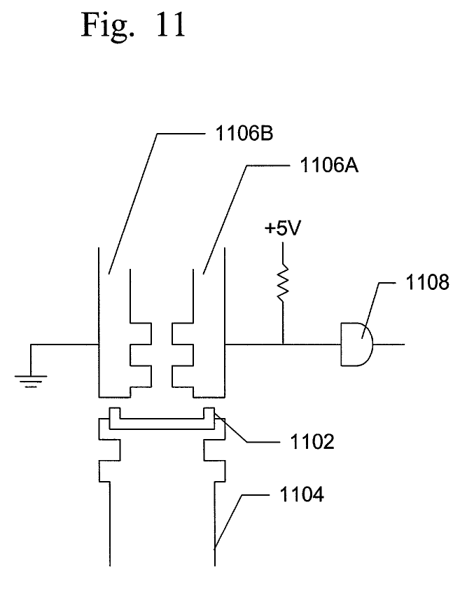

Once the pin has been inserted into the cross-point, robotic cross connector 604 then verifies that the pin has been successfully inserted, as shown in FIG. 11. In addition to the metal contacts on the shaft of each pin that form the connections, there is also a metal strip 1102 attached to each pin, such as pin 900. The robot verifies the pin position by sending a small current from one hand 1106A to the other hand 1106B. The metallic parts of the robot hand are electrically insulated from each other. Hand 1106B is connected to the ground and hand 1106A is connected to current detector 1108. When the hands touches the metallic strip on the head of connect pin, current flows through the pin and the output of detector 1108 will change states if the insertion is good. If the insertion is not good then the output of detector 1108 will not change.

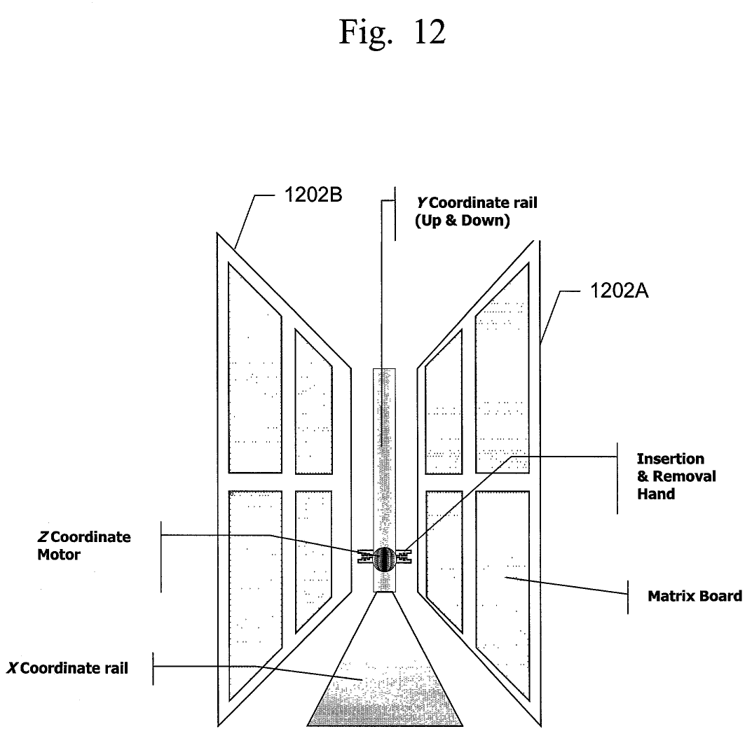

An example of matrix boards in relation to the robotic cross connector is shown in FIG. 12. As shown, typically two mother boards 1202A and 1202B, upon which matrix boards are mounted, one robotic cross connector 604, and the additional circuitry are grouped to form a cross connect subsystem. Multiple such subsystems may be grouped to create a larger cross-connect. Single and three tier designs may be achieved.

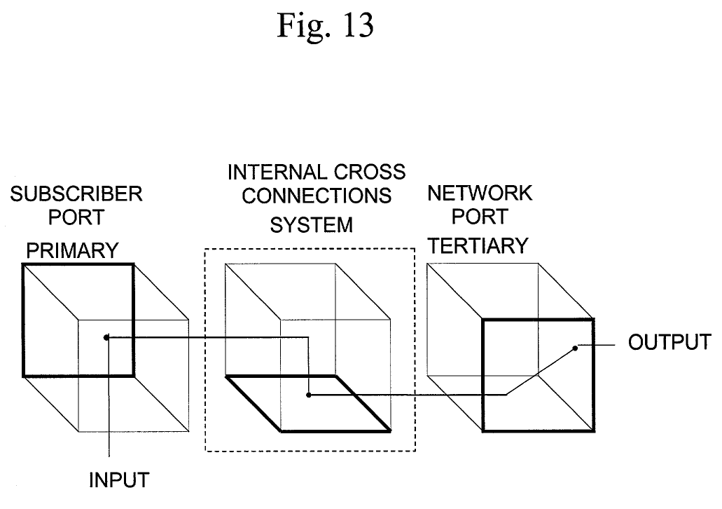

FIGS. 13-18 illustrate some standard 3 dimensional (3 tier) connection paths, which are completed by the cross connect switch in response to commands.

According to another embodiment of the present invention, the cross-connect switch may be implemented between the central office and one or more end user locations. For example, the cross connect may be implemented at nodes that are connected to central offices and distribute wiring to subscriber locations, such as pole mounted facilities or curb-side boxes that service local communities of subscribers.

Conventionally, each remote node includes a manual patch panel for connecting wires that originate from a central office to wires that lead to subscriber locations. In order to make a change in service for a subscriber, typically the service provider or telephone company has had to dispatch a technician to the node. The technician, upon arrival, must spend typically from 30 minutes to an hour to a) setup a tent around the box or pole if in harsh weather, b) open the box or pole mounted facility, c) identify the wire that leads to the subscriber who desires a change in service, c) identify the central office wire for the new service and then, d) make a new connection on the patch panel between the selected central office wire and the customer's wire to establish the new service. This procedure conventionally must be followed for each service changes at a subscriber location. In addition the actual wiring within the box or pole may at times differ from the documented version of the service database. In such cases, the discrepancies must be corrected prior to completing the above mentioned tasks.

According to an embodiment of the present invention, the manual patch panel may be replaced by a remote controlled cross-connect switch. In order to facilitate installation of the cross-connect switch, the cross-connect switch may be initially pre-connected to match connections with-in the patch panel. This may be done automatically by accessing a service database at the central office to obtain the configuration of the patch panel for replacement. This configuration may then be imposed onto the cross-connect switch by commanding the cross-connect switch to reproduce the connections of the patch panel as defined in the service database.

The pre-configured cross-connect switch may then be installed in the remote node. This may be done by wiring the cross-connect in parallel with the existing patch panel to prevent service interruption. Once the connections are verified pursuant to test routines, the patch panel may be disconnected leaving the remote cross-connect to take over. Performing the installation in this manner prevents service outages.

According to an embodiment of the present invention, the cross-connect switch includes an associated remote controller which receives service change commands. Upon receiving a service change command, the remote controller causes the cross-connect to automatically connect (or disconnect) a subscriber to (or from) a new central office line for providing (or discontinuing) a service. In this manner, changes in service can be made at remote nodes from an automated or semi-automated central locations, without dispatching any technicians to the remote site or to a central office. In addition, the changes can be made in a matter of seconds, rather than hours or days.

The remote controller that controls the cross-connect installed at remote nodes such as in pole mounted nodes may be the same as that described with reference to the Figures. The remote controller may be coupled to the Network Operations Center (NOC) for receiving commands relating to subscriber changes in any convenient manner. For example, the remote controller may be coupled via a dial up line, via a Leased line, a central office line, a wireless link, a LAN, a WAN (including over the Internet) or by any other convenient link. In addition, the remote controller may communicate with the NOC through any convenient protocol including TL1, CORBA, TCP and SNMP to name a few. When either or both of the central office and pole-mount or curb side installations include cross-connects configured as shown and described herein tremendous savings of time, money and manpower are achieved.

Although specific embodiments of the present invention have been described, it will be understood by those of skill in the art that there are other embodiments (for example relay based cross-connects, etc.) that are equivalent to the described embodiments. Accordingly, it is to be understood that the invention is not to be limited by the specific illustrated embodiments, but only by the scope of the appended claims.

What is claimed is:

1. A method of provisioning telecommunications services provided by competitive entities within a central office, comprising the steps of:
providing a cross connect switch;
providing a main distribution frame for coupling a plurality of subscriber terminals to the central office;
coupling the cross connect switch to the main distribution frame, a telecommunications switch within a central office and at least two separately controlled pieces of service provider equipment, each piece of equipment having multiple ports coupled to the cross connect switch;
providing a remote server for creating interconnections between a specified port of one piece of service provider equipment and a specified port of another piece of service provider equipment.

3. The method according to claim 1, wherein each piece of service provider equipment comprises a DSLAM.

4. The method according to claim 2, wherein the DSLAM provides SDSL service.

5. The method according to claim 2, wherein the DSLAM provides ADSL service.

6. The method according to claim 2, wherein the DSLAM provides ADSL service over a shared line.

7. The method according to claim 2, wherein the DSLAM provides HDSL service.

8. The method according to claim 2, wherein the DSLAM provides VoDSL service.

9. The method according to claim 2, wherein the DSLAM provides SHDSL service.

10. The method according to claim 2, wherein the DSLAM provides VDSL service.
